(19) United States
(12) Patent Application Publication
(10) Pub. No.: US 2017/0094373 A1
(43) Pub. Date: Mar. 30, 2017

(54) AUDIO/VIDEO STATE DETECTOR

(71) Applicant: Verance Corporation, San Diego, CA (US)

(72) Inventor: Patrick George Downes, San Diego, CA (US)

(21) Appl. No.: 15/281,002

(22) Filed: Sep. 29, 2016

Related U.S. Application Data
(60) Provisional application No. 62/234,595, filed on Sep. 29, 2015.

(51) Int. Cl. H04N 21/8545; H04N 21/8358; H04N 21/485; H04N 21/442

(52) U.S. Cl. CPC H04N 21/8545; H04N 21/44218; H04N 21/8358; H04N 21/4852; H04N 21/4854

(57) ABSTRACT

Methods, devices, systems and computer program products facilitate modifying interactive television applications in systems where metadata is carried by watermarks. The embodiments address situations where a user attempts interaction with an intermediate device while the television is executing an application which is replacing the video and/or audio from the original content stream. In particular, a process runs on the television which analyzes the audio and/or video and detects when user interaction is occurring upstream of the television. In response to the detection, the interactive television application may be terminated or the content may be modified so that the upstream activity will not be affected by the interactive television application.

### CROSS REFERENCE TO RELATED APPLICATIONS

This application claims the benefit of priority of U.S. Provisional Patent Application No. 62/234,595, filed Sep. 29, 2015, the entire contents of which are incorporated by reference as part of the disclosure of this document.

### TECHNICAL FIELD

The subject matter of this patent document relates to management of multimedia content and more specifically to facilitating the modification of interactive television applications to improve the user experience during interactivity while the television is running an application which is replacing the original content stream.

### BACKGROUND

The use and presentation of multimedia content on a variety of mobile and fixed platforms have rapidly proliferated. By taking advantage of storage paradigms, such as cloud-based storage infrastructures, reduced form factor of media players, and high-speed wireless network capabilities, users can readily access and consume multimedia content regardless of the physical location of the users or the multimedia content. A multimedia content, such as an audiovisual content, can include a series of related images, which, when shown in succession, impart an impression of motion, together with accompanying sounds, if any. Such a content can be accessed from various sources including local storage such as hard drives or optical disks, remote storage such as Internet sites or cable/satellite distribution servers, over-the-air broadcast channels, etc.

In some scenarios, such a multimedia content, or portions thereof, may contain only one type of content, including, but not limited to, a still image, a video sequence and an audio clip, while in other scenarios, the multimedia content, or portions thereof, may contain two or more types of content such as audiovisual content and a wide range of metadata. The metadata can, for example include one or more of the following: channel identification, program identification, content and content segment identification, content size, the date at which the content was produced or edited, identification information regarding the owner and producer of the content, timecode identification, copyright information, closed captions, and locations such as URLs where advertising content, software applications, interactive services content, and signaling that enables various services, and other relevant data that can be accessed, In general, metadata is the information about the content essence (e.g., audio and/or video content) and associated services e.g., interactive services, targeted advertising insertion).

Such metadata is often interleaved, prepended or appended to a multimedia content, which occupies additional bandwidth, and can be lost when content is transformed into a different format (such as digital to analog conversion, transcoded into a different file format, etc.), processed (such as transcoding), and/or transmitted through a communication protocol/interface (such as HDMI, adaptive streaming). Notably, in some scenarios, an intervening device such as a set-top box issued by a multichannel video program distributor (MVPD) receives a multimedia content from a content source and provides the uncompressed multimedia content to a television set or another presentation device, which can result in the loss of various metadata and functionalities such as interactive applications that would otherwise accompany the multimedia content. Therefore alternative techniques for content identification can complement or replace metadata multiplexing techniques.

### BRIEF DESCRIPTION OF THE DRAWINGS

FIG. 1 illustrates a system for providing automatic content recognition and acquisition of metadata in accordance with an exemplary embodiment.

FIG. 2 illustrates an example of the display of underlying content along with a display resulting from interactivity where the display has been recomposed in accordance with an exemplary embodiment.

FIG. 3 illustrates an example of the display of underlying content along with a display resulting from interactivity where the display has been recomposed in accordance with an exemplary embodiment.

FIG. 4 illustrates an example of the display of underlying content along with a display resulting from interactivity where the display has been recomposed in accordance with an exemplary embodiment.

FIG. 5 illustrates an example of the display of underlying content along with a display resulting from interactivity where the display has been recomposed in accordance with an exemplary embodiment.

FIG. 6 illustrates an example of the display of underlying content along with a display resulting from interactivity where the display has been recomposed in accordance with an exemplary embodiment.

FIG. 7 illustrates an example of the display of underlying content along with a display resulting from interactivity where the display has been recomposed in accordance with an exemplary embodiment.

FIG. 8 illustrates an example of the display of underlying content along with a display resulting from interactivity where the display has been recomposed in accordance with an exemplary embodiment.

FIG. 9 illustrates an example of the display of underlying content along with a display resulting from interactivity where the display has been recomposed in accordance with an exemplary embodiment.

FIG. 10 illustrates a block diagram of a device that can be used for implementing various disclosed embodiments.

### SUMMARY OF CERTAIN EMBODIMENTS

The disclosed technology relates to methods, devices, systems and computer program products that facilitate the modifying of interactive television applications to improve the user experience during interactivity while the television is running an application which is replacing the original content stream.

One aspect of the disclosed embodiments relates to a method for modifying interactive television applications that includes detecting either activity upstream of the television or a user's interactivity with an intermediate device. In response to the detecting, the interactive television application may be terminated or the audio and/or video content can be changed so as to not obscure the activity upstream of the television.

### DETAILED DESCRIPTION

In the following description, for purposes of explanation and not limitation, details and descriptions are set forth in order to provide a thorough understanding of the disclosed embodiments. However, it will be apparent to those skilled in the art that the present invention may be practiced in other embodiments that depart from these details and descriptions.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

New television standards, such as ATSC 3.0 allow applications to run on a TV to provide interactive services, targeted advertising with local ad replacement, audience measurement, video-on-demand, etc.

The TV manages the runtime of the applications and synchronizes the applications to the underlying audio-video content. To do this synchronization, the TV must be able to identify the content and what part of its timeline is currently being rendered. An example of such a content management system is described in more detail in U.S. patent application no. US 2015/0264429, entitled “Interactive Content Acquisition Using Embedded Codes,” which is attached hereto as Appendix A. in some cases that identification and synchronization information is signaled in digital metadata which is transported with the content through a broadcast or broadband channel that the TV directly receives.

However, in other cases the metadata is carried by audio or video watermarks embedded in the content, and that embedded content passes through intermediate devices such as Set Top Boxes (STB) or Audio Video Receivers (AVR). An example of this is when the content is received in a Set-Top-Box which transmits it to a TV via HDMI.

In such a system (i.e. systems where metadata is carried by watermarks) a problem arises when the user attempts interaction with the intermediate device while the TV is executing an application which is replacing the video and/or audio from the original content stream.

FIG. 1 illustrates such a system. In particular, FIG. 1 shows a system 10 that includes a Multichannel Video Programming Distributor (MVPD) 12 which sends programming, for example through a cable TV connection, to a set top box (STB) 14, which includes a user interface (UI) such as a remote control 16. The STB 14 has a High Definition Multimedia Interface (HDMI) output to an Audio/Video Receiver (AVR) 18. The AVR 18 has an HDMI output to an ATSC 3.0 television 20, which has a broadband connection 22 to the internet. The television 20 includes, or is connected to, an Audio/Video State Detector 24, which is described in more detail below.

In using the system 10, a user might try to view an Electronic Program Guide (“EPG”) by pressing the appropriate button on the STB's remote control 16. The STB 14 would overlay the EPG on the content, but the EPG overlay and the original content might be obscured by the replacement audio and video presented by the TV application. This results in a confusing user experience where the system appears unresponsive to the user's actions.

Similarly, there might be notifications created by an upstream device (e.g. the AVR 18 or the STB 14 that are not triggered by the user's actions but by some external event. An example of this is a notification pop-up window that is displayed with caller information when the telephone rings. Another example is a pop-up alert with important news or emergency notification.

A general goal of the disclosed embodiments is this: for a consistent and intuitive user experience, interactive apps or inserted ads running on a TV 20 should not obscure the audio or visual results of user interaction with a STB 14 or obscure notifications for the user presented by the STB 14 or other upstream device. This goal can be achieved by making the TV 20 aware of any user interactions with intermediate devices or upstream notifications and to terminate or modify the application to avoid obscuring the results of the user's actions.

In some cases the upstream activity will cause a modification to the audio or video watermark, and that modification can be detected by a watermark detector. For example, if the user presses ‘Mute’ on the STB 14, an audio watermark would be undetectable because the audio input to the watermark detector would be silenced. Another example is if the video content were scaled and placed in a PIP when the user selects an Electronic Program Guide such that the video scaling might destroy a video watermark. In both of these cases, the watermark detectors can recognize the upstream activity, and can then notify the application runtime system that the content has been modified, which could result in termination, suspension or modification of the application to avoid interfering with the upstream activity.

However, in other cases, both the audio and the video watermark would not be affected by the user's STB interaction and the watermark detectors would be unaware of that interaction. For example, if the user selects an EPG which does a partial overlay on the screen which does not affect the video watermark and which does not alter the audio, then the watermark detectors have no information which can be used to terminate the application so that user can see the EPG.

Custom solutions could be designed where a newly designed upstream device could actively signal the TV that there is upstream user interactivity. It could do this by intentionally modifying the watermarks, or it might use side channel communication such as a new protocol implemented in HDMI. However, this is not a general solution because it cannot be used with legacy devices.

The present embodiments address the general case (i.e. cases other than the custom solutions described in the preceding paragraph) by having a process running on the TV which analyzes the audio and/or video and detects when user interaction is occurring upstream of the TV.

A/V State Detection. One solution is to have the TV detect the changes in the audio and/or video content due to upstream activity using the AVSD 24 shown in FIG. 1, as described below. An advantage of this solution is that it does not require custom implementations by the upstream device, which allows its use with legacy devices.

Template Matching. Well known image processing techniques can be used to detect video changes due to upstream activity. For example, see https://en.wikipedia.org/wiki/Template_matching. Some of the changes in the video due to upstream activity are time invariant, for example the bounding rectangle and logo of an EPG, while some of the video changes are dynamic in time, for example the contents of the EPG. The AVSD 20 can detect the time invariant changes in video with a simple pattern matching algorithm which compares stored templates of the upstream activity to the displayed image pixel-by-pixel or with a more elaborate algorithm which extracts features of the image, comparing those features to a stored description of those features.

This detection task is relatively simple: unlike applications such as face detection and scene understanding, the objects to be detected here are fixed scale, fixed position and fixed rotation, two dimensional video overlays which can be detected with simple pattern recognizers. The task is further simplified because the overlays are time invariant, and fixed-template spatial pattern recognizers can be used. A collection of stored templates representing all possible upstream activity can be used in an iterative search of a video frame by comparing each template to the video frame.

In a simple recognizer the template can be bounded by a rectangle which is only as large as needed to reliably identify the upstream activity. The size of the rectangle and its position in the video frame must be specified.

The template is compared to the corresponding region of the video frame by doing a pixel-by-pixel comparison and declaring a match if the comparison indicates a strong correlation between the template and the corresponding region in the video frame. An example of a comparison function would be simple distance function between the RGB values. The threshold used for declaring a match can be tuned and set independently for each template, so that, for example, the threshold for an upstream video overlay which is opaque can be set higher than the threshold for a video overlay which is partially transparent.

Upon detection of a template match, confirmation can be made by matching the same template in several subsequent frames to minimize false positive detections. Only the time invariant parts of the upstream activity should be compared, so a mask can be applied to indicate areas within the bounding rectangle which correspond to dynamic overlaid content which will not be included in the comparison. This can be done with a separate mask, or it can be done by reserving one value for the pixel vector to indicate that the pixel is not to be used in the comparison.

Another way to mask the dynamic elements of the upstream activity is to use a set of rectangles for each template, where the rectangles only include the time-invariant elements. For example the border of an EPG could be represented by four rectangles, which as a set would comprise the template.

As subsequent pixels in a template are compared to the video, a running sum of the match value can be kept. A template match can be declared when enough pixels match; and the template can be rejected at any time the average accumulated match value crosses a lower threshold. The choice of these thresholds depends on the system constraints for processing resources vs false positive rate and the false negative rate. These thresholds can also be set independently for each template to account for variations found in the templates when creating the templates.

As an optimization to reduce required processing resources, it is not crucial that every template be considered every frame as long the template match can be declared quickly enough that the UI can remain responsive. For instance if there are 30 frames per second and the goal is to terminate the application within 0.5 seconds of the upstream activity, and you require template matches in three consecutive frames to declare a match, then there should be an attempt to match all templates within 12 frames. To improve responsiveness, the system can keep a record of the history of matched templates and adapt the order and frequency of template matching attempts based on that history so that attempts to the most commonly encountered upstream activity templates can occur more frequently with higher priority.

The template matching process only needs to run when there is interactive content which might be obscuring the upstream activity. If there is no interactive TV application running, the template matching can be suspended. If an application is running, it can report to the TV the display regions it is using, and this information can be used to determine whether there is a conflict with a template. If there is no conflict, then that template can be skipped in the iteration through templates.

Notification/Reporting. Upon confirmation of upstream activity, the AVSD 24 can notify apps that there is user interaction upstream, including details about the type of interaction. Upon receiving the notification the app can take appropriate action, For example it might terminate; or it might suspend its display until the upstream user interaction ends; or it might recompose its display to coexist with the underlying content and upstream user interactivity.

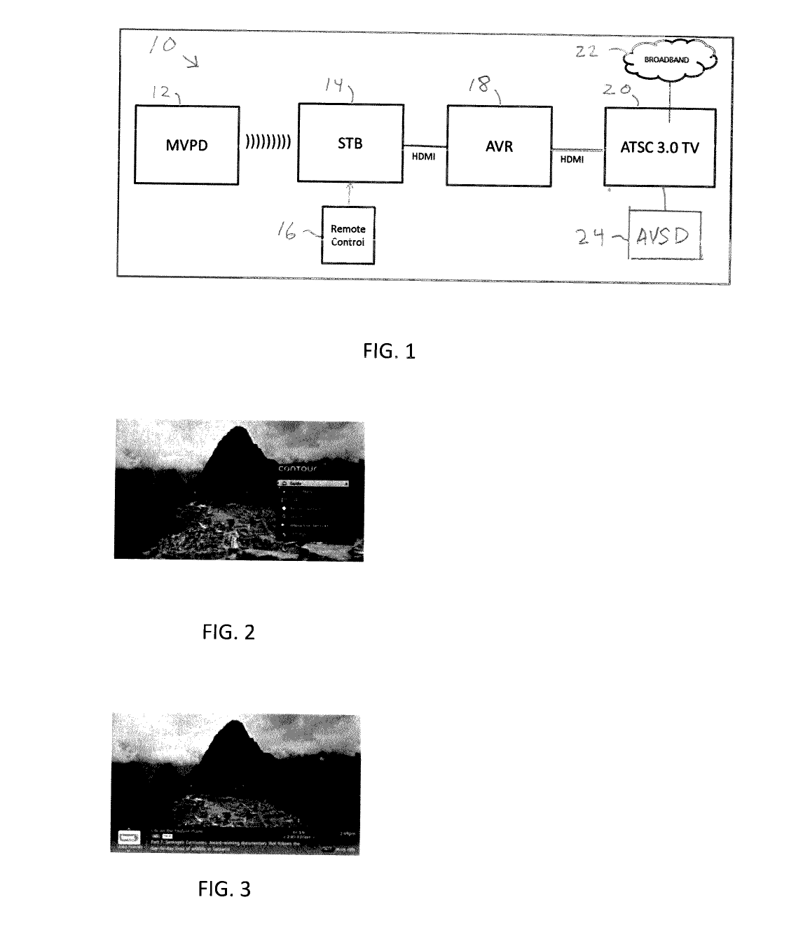

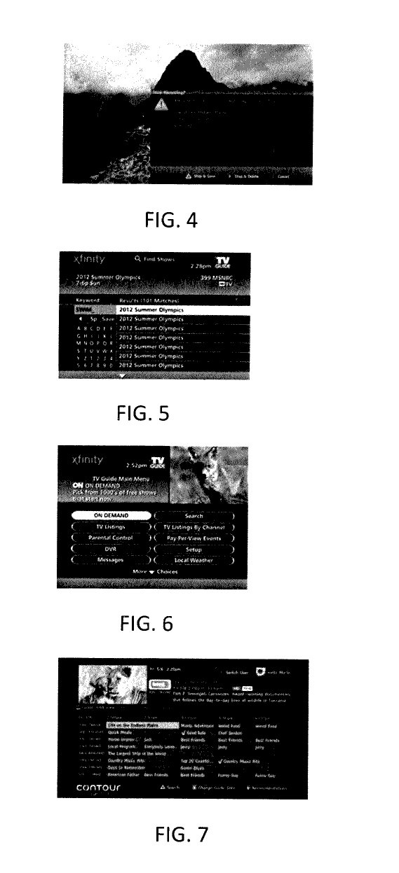

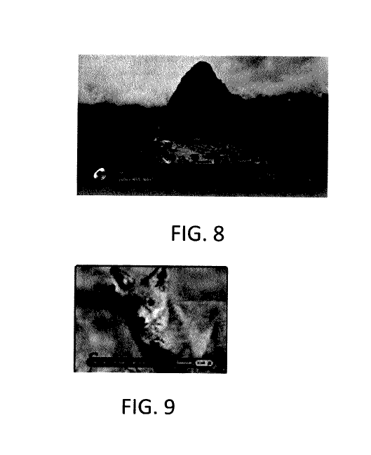

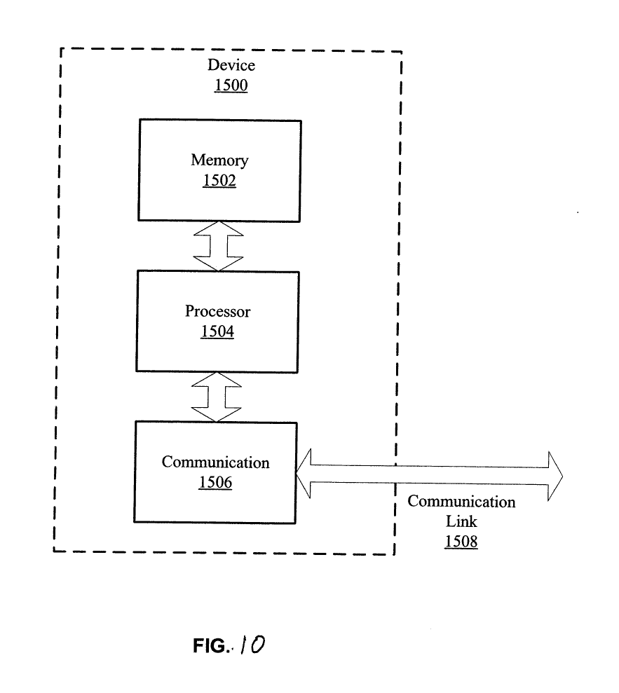

FIGS. 2-9 illustrate some upstream re-composition examples in accordance with the exemplary embodiments. In particular, FIG. 2 shows the underlying content (depicting a mountain) with an overlay consisting of the STB on-screen menu, which is inset and partially overlaying. FIG. 3 shows the underlying content (depicting a mountain) with an overlay consisting of the STB program information in a partial overlay that covers the bottom of the screen. FIG. 4 shows the underlying content (depicting a mountain) with an overlay consisting of a DVR alert in a partial overlay covering the bottom corner of the screen. FIG. 5 shows the STB program guide completely overlaying the screen. FIG. 6 shows the STB program guide completely overlaying the screen with the underlying content in a scaled picture-in-picture (PIP). FIG. 7 shows the STB program guide completely overlaying the screen with the underlying content in a scaled picture-in-picture (PIP) insert. FIG. 8 shows a caller ID notification overlay at the bottom of the screen. FIG. 9 shows a caller ID notification overlay in a partial overlay inset.

Template Database. The use of the Fixed Template Pattern Recognizer requires having a template for each instance of upstream activity. The local database of templates could be built during a setup/configuration process where the user could train the system. For instance, a learning mode could be implemented with simple instructions to the user to activate each upstream activity while the TV analyzes the audio and video and creates templates based on the detected changes in the AV stream. That step could be repeated several times for each activity to ensure that the time-invariant parts of the upstream activity are identified and represented in the templates, and that detection thresholds are set correctly.

There will be a set of templates associated with each model of upstream device, and these could be collected in remote repositories that TVs could access. These repositories could be filled by equipment manufacturers, service providers, or by user contributions created in the learning mode described above.

TVs could remotely access repositories of these templates to populate the local database for the template matching system. Accessing remote repositories could shorten the setup/configuration activity for the user by enabling complete local database population based on the user selecting the device model number from a list, or by shortening the learning mode described above by recognizing the model of the device by comparing locally generated templates to ones from the remote database without requiring the user to activate all possible upstream activities.

Advanced Pattern Recognizers. The use of the Fixed Template Pattern Recognizer requires having a template for each instance of upstream activity. Algorithmic approaches to detect upstream activity are possible which do not require the use of templates, but which require more processing resources. For instance, EPGs from different STB manufactures share some common elements, including the use of scrolling lists of text items, rectangular boundaries, or the logo of the service provider. Candidates found with these simple heuristics could be compared to templates from a remote repository, and when a match is found, the entire set of templates for the same piece of equipment can be used to populate the local template database. In this way, no user action is required to configure the system.

FIG. 10 illustrates a block diagram of a device 1500 within which various disclosed embodiments may be implemented. The device 1500 comprises at least one processor 1504 and/or controller, at least one memory 1502 unit that is in communication with the processor 1504, and at least one communication unit 1506 that enables the exchange of data and information, directly or indirectly, through the communication link 1508 with other entities, devices, databases and networks. The communication unit 1506 may provide wired and/or wireless communication capabilities in accordance with one or more communication protocols, and therefore it may comprise the proper transmitter/receiver, antennas, circuitry and ports, as well as the encoding/decoding capabilities that may be necessary for proper transmission and/or reception of data and other information. The exemplary device 1500 of FIG. 10 may be integrated as part of any devices or components described in this document to carry out any of the disclosed methods.

The components or modules that are described in connection with the disclosed embodiments can be implemented as hardware, software, or combinations thereof. For example, a hardware implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application.

Various embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), Blu-ray Discs, etc. Therefore, the computer-readable media described in the present application include non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

For example, one aspect of the disclosed embodiments relates to a computer program product that is embodied on a non-transitory computer readable medium. The computer program product includes program code for carrying out any one or and/or all of the operations of the disclosed embodiments.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products, as well as in different sequential orders. Any embodiment may further be combined with any other embodiment.

What is claimed is:

1. A method for modifying interactive television applications comprising:
detecting either activity upstream of the television or a user's interactivity with an intermediate device; and
in response to the detecting taking an action including at least one of: (a) terminating the interactive television application; or (b) changing audio and/or video content so as to not obscure the activity upstream of the television.

2. A method for modifying interactive television applications according to claim 1 wherein the detecting further comprises recognizing an image.

3. A method for modifying interactive television applications according to claim 2 wherein the detecting further comprises detecting user interface elements from the upstream activities.

4. A method for modifying interactive television applications according to claim 3 wherein the detecting further comprises performing fixed template pattern recognition.

5. A method for modifying interactive television applications according to claim 4 wherein the fixed template pattern recognition does not attempt to find a match in every frame.

6. A method for modifying interactive television applications according to claim 4 wherein the fixed template pattern recognition determines whether there is a conflict with a template based on a report from the application regarding the display regions it is using.

7. A method for modifying interactive television applications according to claim 6 wherein if there is no conflict then that template is skipped by the fixed template pattern recognition in an iteration through the templates.

8. A method for modifying interactive television applications according to claim 4 further comprising:
keeping record of the history of matched templates; and
adapting the order and frequency of template matching attempts based on the history, whereby attempts to the most commonly encountered upstream activity templates can occur more frequently and with higher priority.

9. A method for modifying interactive television applications according to claim 4 further comprising masking the dynamic elements of the upstream activity by using a set of rectangles for each template, where the rectangles include time-invariant elements.

10. A method for modifying interactive television applications according to claim 4 further comprising:
generating a set of templates associated with each model of upstream device; and
collecting the set of templates in a remote database repository that is accessible by the television.

11. A method for modifying interactive television applications according to claim 10 further comprising:
recognizing the model of the device; and
comparing locally generated templates to ones from the remote database repository without having the user to activate all possible upstream activities.

12. A method for modifying interactive television applications according to claim 1 wherein the detecting further comprises:
detecting common elements;
comparing these common elements to templates from a remote repository;
determining when a match is found; and
populating a local template database using an entire set of templates for a given piece of equipment.

13. A method for modifying interactive television applications according to claim 1 wherein the user interactivity comprises activating a mute function wherein a watermark detector cannot detect an audio watermark.

14. A method for modifying interactive television applications according to claim 1 wherein the user interactivity comprises activating a picture-in-picture function wherein a watermark detector cannot detect a video watermark.

15. A device, comprising:
a processor; and
a memory comprising processor executable code, the processor executable code when executed by the processor configures the device to:
detect either activity upstream of the television or a user's interactivity with an intermediate device; and
in response to the detecting taking an action including at least one of: (a) terminating the interactive television application; or (b) changing audio and/or video content so as to not obscure the activity upstream of the television.
